(19) United States
(12) Patent Application Publication
(10) Pub. No.: US 2009/0172048 A1
(43) Pub. Date: Jul. 2, 2009

(54) MEMORY STORAGE OF FILE FRAGMENTS

(75) Inventors: R. Scott Tetrick, Portland, OR (US); Glenn Hinton, Portland, OR (US); Dale Juenemann, North Plains, OR (US)

Correspondence Address: INTEL CORPORATION;c/o CPA Global, P.O. BOX 52050, MINNEAPOLIS, MN, 55402, US

(73) Assignee: Intel Corporation, Santa Clara, CA (US)

(21) Appl. No.: 11/968,033

(22) Filed: Dec. 31, 2007

(51) Int. Cl. G06F 12/02; G06F 12/00

(52) U.S. Cl. 707/205; 711/112; 707/E17.01; 711/E12.001

(57) ABSTRACT

In some embodiments a beginning portion of a disk drive file fragment is stored in a memory, and the beginning portion of the disk drive file fragment is accessed from the memory. Other embodiments are described and claimed.

### TECHNICAL FIELD

The inventions generally relate to memory storage of file fragments.

### BACKGROUND

Physical files stored on a hard disk drive are not always contiguous on the disk drive even though a user is not typically aware of it. In fact, physical files are often split up into file fragments on the disk drive. Such file fragments add to the uncertainty of accesses from the disk, and may cause isochronous deadlines to be missed. This can result in non-desired results such as screen flicker or sound pops. The file system of the Operating System (OS) is responsible for the allocation of files to specific sectors on the hard disk drive. Changes in the file system can cause multiple file fragments to occur. A sample file and its fragmentation are shown below:

```
File 2303
\Windows\System32\LogFiles\Scm\SCM.EVM
    $STANDARD_INFORMATION (resident)
    $FILE_NAME (resident)
    $DATA (nonresident)
        logical sectors 11004712-11004775 (0xa7eb28-0xa7eb67)
        logical sectors 11045440-11045567 (0xa88a40-0xa88abf)
        logical sectors 27538272-27538527 (0x1a43360-0x1a4345f)
        logical sectors 26954584-26955095 (0x19b4b58-0x19b4d57)
```

If such a fragmented file is accessed, each fragment in the file means that a disk seek must be performed. Once the seek is completed, the data may be transferred from the disk. A heavily fragmented system impacts a user's response time. Therefore, in many systems using Windows Operating System, for example, there is a need to manually invoke a “DEFRAG” utility once in a while in order to defragment the fragmented files. File fragments can result in additional seek times and also in additional rotations of the disk drive. Therefore, a need has arisen to reduce the negative delays associated with file fragments on a disk drive.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a disk drive according to some embodiments of the inventions.

FIG. 2 illustrates a system according to some embodiments of the inventions.

### DETAILED DESCRIPTION

Some embodiments of the inventions relate to memory storage of file fragments.

In some embodiments a beginning portion of a disk drive file fragment is stored in a memory, and the beginning portion of the disk drive file fragment is accessed from the memory (for example, in response to a disk access request to access the file fragment from the disk drive).

In some embodiments an article includes a computer readable medium having instructions thereon which when executed cause a computer to store a beginning portion of a disk drive file fragment in a memory, and to access the beginning portion of the disk drive file fragment from the memory.

In some embodiments a memory is to store a beginning portion of a disk drive file fragment, and a processor is to access the beginning portion of the disk drive file fragment from the memory.

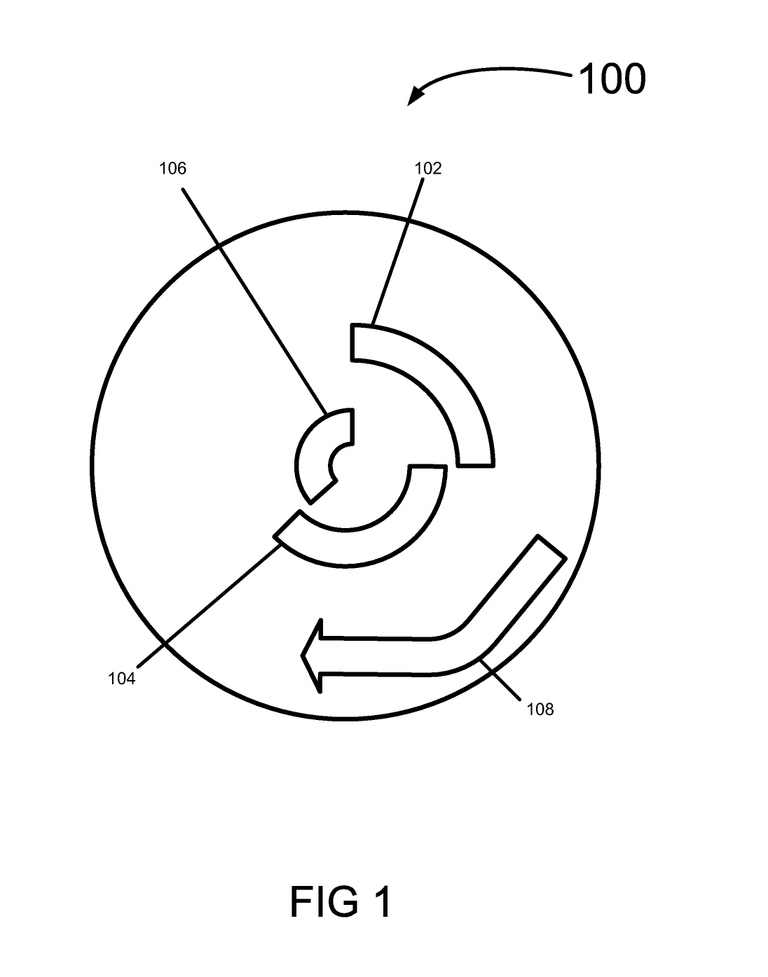

FIG. 1 illustrates a disk drive 100 according to some embodiments. In some embodiments disk drive 100 has a file stored thereon in three file fragments 102, 104, and 106. FIG. 1 illustrates the fragments 102, 104, and 106 as they are laid out on the disk 100. Arrow 108 illustrates a direction of rotation of the disk during disk access activities. Each of the fragments 102, 104, and 106 represents a portion of the disk track that makes up a portion of the file. The file is to be accessed in order from fragment 102, then fragment 104, and then fragment 106. At the beginning of fragment 102 a disk seek is necessary to find the fragment. Then when the access to fragment 102 is completed, the disk 100 cannot start accessing and transferring fragment 104 because of the latency associated with moving the disk head. This requires the disk 100 to rotate until the beginning of fragment 104 is under the disk head. Similarly, moving access from fragment 104 to fragment 106 requires a full rotation of the disk 100. In a fragmented file situation where the file fragments 102, 104, and 106 must be accessed, due to the requirement for head movement, three seeks and three full rotations are required to complete the task of accessing the entire fragmented file.

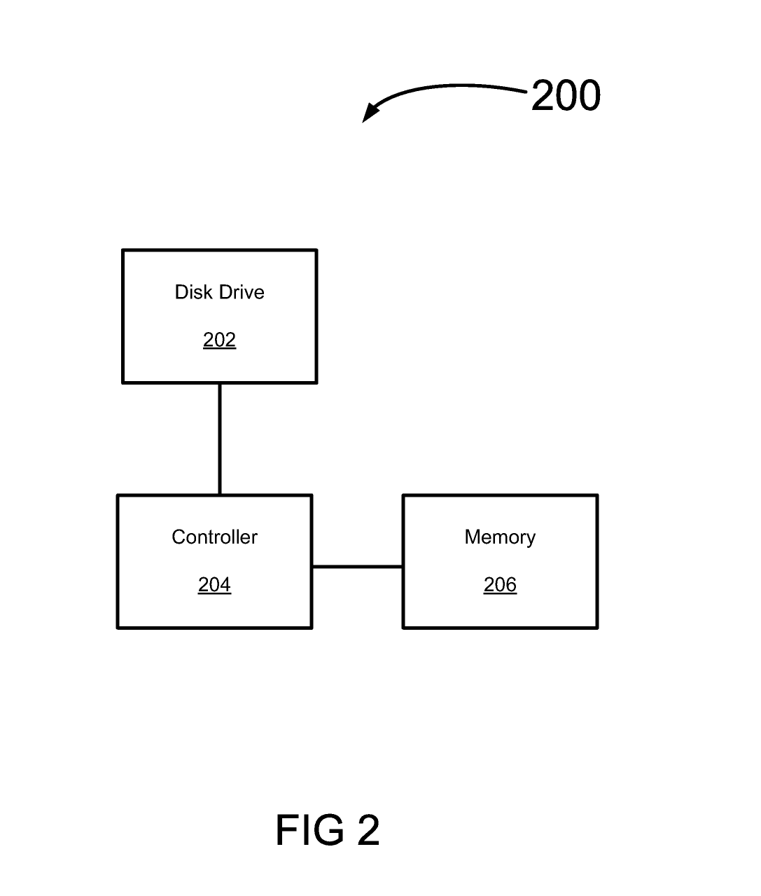

FIG. 2 illustrates a system 200 according to some embodiments. In some embodiments, system 200 includes a disk drive 202, a controller 204, and a memory 206. In some embodiments, memory 206 is a non-volatile memory such as, for example, a flash memory. In some embodiments, memory 206 is non-volatile memory provided on a platform including the controller 204. In some embodiments controller 204 stores a beginning portion of some or all fragments occurring on disk drive 202. When controller 204 is waiting for disk drive 202 to begin accessing a file fragment the controller 204 can access the memory 206 to obtain access to the beginning portion of that file fragment. In some embodiments the beginning portion of the file fragment stored in memory 206 is large enough so that once the beginning portion has been accessed by controller 204 from memory 206 then the disk drive 202 is ready to provide the remainder of the file fragment (if any) to the controller 204.

In some embodiments, memory 206 can be used along with knowledge of file fragmentation to obtain smooth disk access and meet all isochronous requirements. If the beginning portion of each fragment is stored (or cached) into memory 206 and that beginning portion is a big enough portion, the need for waiting for extraneous rotations can be reduced and/or eliminated and a user's needs are better satisfied.

In some embodiments, for a fragment (and/or for each fragment on a disk drive) the following equation applies:

$$\frac{n \times S}{{t}_{seek} + \frac{n \times S}{{b}_{disk}}} \geq {b}_{isoch}$$

In the above equation, n is the number of sectors to store in the memory (or cache), S is the number of bytes per sector (this number is usually 512), tₛₑₑₖ is the seek time estimated for the disk (this should include any disk revolution times needed to cover the latency), bdisk is the data bandwidth of the disk, and b_{isoch} is the desired isochronous rate. Solving this equation for n, the following is obtained:

$$n \geq \frac{{b}_{isoch} \times {t}_{seek}}{S ( 1 - \frac{{b}_{isoch}}{{d}_{disk}} )}$$

For example, solving this for the typical parameters for current disk drives, where S=512, tseek=0.015+0.01 seconds (seek time plus one rotation), b_{disk}=50 MB/sec, b_{isoch}=2.5 MB/sec (20 Mbit/sec is equivalent to high definition TV), a value for n of approximately greater than or equal to 133.6 sectors is obtained. Therefore, in some embodiments, data rate requirements covering all disk fragmentation may be met by storing (or caching) the beginning 134 sectors of each file fragment. In some embodiments, it is noted that for file fragments shorter than n (or shorter than 134 in this case) the entire file fragment should be stored (or cached). In some embodiments, such an entirely stored (or cached) file fragment may be deducted from the storage (or cache) requirements for the next file fragment. In some embodiments, if the first fragment of a file is stored (or cached) in this manner benefits include a faster application launch, for example.

In some embodiments, a better isochronous experience may be obtained. Glitches in audio and video may be minimized or eliminated, and a user experience similar to a consumer electric (CE) device is possible using typical personal computer (PC) components.

Some embodiments have been described herein as being implemented using a controller. It is noted that the controller may in some embodiments be a processor (for example, a Central Processing Unit or CPU of a computer or some other processor). For example, in some embodiments, implementations may include a controller (and/or processor) within a chipset. In some embodiments, implementations of the controller may include driver software. Some embodiments may include a controller implemented in hardware, software, and/or firmware.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
storing a beginning portion of a disk drive file fragment in a memory; and
accessing the beginning portion of the disk drive file fragment from the memory.

2. The method of claim 1, further comprising after accessing the beginning portion of the disk drive file fragment from the memory, then accessing a remaining portion of the disk drive file fragment from a disk drive.

3. The method of claim 1, further comprising calculating a size of the beginning portion to avoid isochronous issues of the data according to disk characteristics and a required isochronous data rate.

4. The method of claim 1, further comprising storing for each of a plurality of file fragments on a disk drive a beginning portion of that disk drive file fragment in the memory.

5. The method of claim 1, wherein the accessing is performed while waiting to access a remaining portion of the disk drive file fragment from a disk drive.

6. The method of claim 1, wherein the beginning portion is the entire disk drive file fragment if a size of the entire disk drive file fragment is less than a certain size.

7. The method of claim 1, wherein the beginning portion is the entire disk drive file fragment if a size of the entire disk drive file fragment is less than a calculated number of sectors to maintain isochronous performance.

8. The method of claim 3, wherein the beginning portion is the entire disk drive file fragment if a size of the entire disk drive file fragment is less than the calculated size.

9. An article comprising:
a computer readable medium having instructions thereon which when executed cause a computer to:
store a beginning portion of a disk drive file fragment in a memory; and
access the beginning portion of the disk drive file fragment from the memory.

10. The article of claim 9, the computer readable medium further having instructions thereon which when executed cause a computer to:
after accessing the beginning portion of the disk drive file fragment from the memory, then access a remaining portion of the disk drive file fragment from a disk drive.

11. The article of claim 9, the computer readable medium further having instructions thereon which when executed cause a computer to calculate a size of the beginning portion to avoid isochronous issues of the data according to disk characteristics and a required isochronous data rate.

12. The article of claim 9, the computer readable medium further having instructions thereon which when executed cause a computer to store for each of a plurality of file fragments on a disk drive a beginning portion of that disk drive file fragment in the memory.

13. The article of claim 9, wherein the access is performed while waiting to access a remaining portion of the disk drive file fragment from a disk drive.

14. The article of claim 9, wherein the beginning portion is the entire disk drive file fragment if a size of the entire disk drive file fragment is less than a certain size.

15. The article of claim 9, wherein the beginning portion is the entire disk drive file fragment if a size of the entire disk drive file fragment is less than a calculated number of sectors to maintain isochronous performance.

16. The article of claim 11, wherein the beginning portion is the entire disk drive file fragment if a size of the entire disk drive file fragment is less than the calculated size.

17. An apparatus comprising:
a memory to store a beginning portion of a disk drive file fragment; and
a controller to access the beginning portion of the disk drive file fragment from the memory.

18. The apparatus of claim 17, the controller further to access a remaining portion of the disk drive file fragment from a disk drive after accessing the beginning portion of the disk drive file fragment from the memory.

19. The apparatus of claim 17, the controller further to calculate a size of the beginning portion to avoid isochronous issues of the data according to disk characteristics and a required isochronous data rate.

20. The apparatus of claim 17, the memory further to store for each of a plurality of file fragments on a disk drive a beginning portion of that disk drive file fragment.

21. The apparatus of claim 17, the controller to access the beginning portion from the memory while waiting to access a remaining portion of the disk drive file fragment from a disk drive.

22. The apparatus of claim 17, wherein the beginning portion is the entire disk drive file fragment if a size of the entire disk drive file fragment is less than a certain size.

23. The apparatus of claim 17, wherein the beginning portion is the entire disk drive file fragment if a size of the entire disk drive file fragment is less than a calculated number of sectors to maintain isochronous performance.

24. The apparatus of claim 19, wherein the beginning portion is the entire disk drive file fragment if a size of the entire disk drive file fragment is less than the calculated size.
